(19) United States
(12) Patent Application Publication
(10) Pub. No.: US 2006/0012831 A1
(43) Pub. Date: Jan. 19, 2006

(54) Electronic watermarking method and storage medium for storing electronic watermarking program

(76) Inventors: Mizuho Narimatsu, Yamato (JP); Kei Kudo, Yokohama (JP); Takeo Tomokane, Kodaira (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/152,066

(22) Filed: Jun. 15, 2005

(30) Foreign Application Priority Data
Jun. 16, 2004 (JP) 2004-178377
Jun. 10, 2005 (JP) 2005-170295

(51) Int. Cl. G06K 15/00

(52) U.S. Cl. 358/3.28

(57) ABSTRACT

When performing processing to embed electronic watermarks in video data constituting digital video content, audio types are discriminated using differences etc. in sampling characteristics for audio data reproduced synchronously with these video data, and the video data domains targeted for the process of embedding electronic watermarks are limited, depending on the audio type.

### INCORPORATION BY REFERENCE

The present application claims priority from Japanese application JP 2004-178377 filed on Jun. 16, 2004, the content of which is hereby incorporated by reference into this application.

### BACKGROUND OF THE INVENTION

The present invention relates to electronic watermarking technology and relates in particular to technology for embedding electronic watermarks in digital video content.

As a technology for the protection, etc., of the copyright of digital video content, there exists electronic watermarking technology. Electronic watermarking technology is a technology which utilizes human perceptive characteristics, with respect to still images, video (moving images), and sound data, etc., to embed electronic watermark information so that it cannot be perceived. The electronic watermark information embedded is copyright information, user information, and the like. E.g., with respect to video data constituting digital video content, electronic watermarking information for the protection, etc., of the copyright regarding the content is embedded by means of a program for the processing of electronic watermarks. Also, by a process of detecting electronic watermarks, watermark information is detected in digital video content data having electronic watermarks included.

In the prior art, in case the electronic watermarking process was performed on video, the electronic watermarking process was unconditionally executed on the whole of the video stream constituting the video, i.e. uniformly with respect to all the frames and all the image domains inside the frames.

In the JP-A-2002-171492 Publication, there is a disclosure concerning technology performing the embedding of electronic watermark information. Specifically, at the time the digital code of the image signal is compressed, a record is made, in an apparatus embedding electronic watermark information into a code-compressed image signal, to the effect that an embedding of electronic watermark information for each MPEG I-frame should be performed. With this technology, the data that can be handled are limited to the MPEG (Moving Picture Experts Group) format.

### SUMMARY OF THE INVENTION

With the conventional method executing the watermarking process with respect to all of the video images, large-scale calculation is required since there is a need to carry out the process with respect to a number of frames and pixels. As a result, there is the problem that the process time is long. In addition, in case one attempts to aim for an acceleration regarding this electronic watermarking process for all of the video images, there is no method other than aiming for an improvement in the performance of the hardware serving as the process execution platform, i.e. an improvement in the performance of the CPU (Central Processing Unit) or the HDD (Hard Disk Drive) access, so there is the problem that a great expense is necessary for a reinforcement of the hardware resources. Moreover, in the case of the watermarking process, if there is the limitation from a performance point of view that the CPU used in the hardware serving as the process execution platform is one having the maximum performance currently available, or the like, there is the problem that the desirable watermarking process performance can not be obtained.

It is an object Detailed Description of the embodiments to provide a technology capable of implementing, relative to the process of embedding electronic watermarks in digital video content, an improvement in the process efficiency and a shortening of the process time by a reduction in the computing volume, even in the case where a reinforcement of the hardware resources can not be expected.

The inventive concepts alleviate the above noted problems with arising when performing the process of embedding electronic watermarks in video data constituting digital video content, and, with the present invention, there is provided a means for this (the process of embedding electronic watermarks) which discriminates audio classes using differences in sampling characteristics, etc., relative to synchronously reproduced audio data and limits the video data domains targeted for processing to embed electronic watermarks, depending on the audio class.

Other objects, characteristics, and advantages of the present invention should be clear from the description hereinafter of the embodiments of the present invention.

### BRIEF DESCRIPTION OF THE DRAWINGS

The drawing figures depict one or more implementations in accord with the present concepts, by way of example only, not by way of limitation. In the figures, like reference numerals refer to the same or similar elements.

FIG. 1 is an explanatory diagram showing a basic outline of the process occurring in an electronic watermarking program.

FIG. 2 is diagram showing characteristics of common analog sound sampling.

FIG. 3 is an explanatory diagram showing the outline of the process of an electronic watermarking program.

FIG. 4 is a block diagram showing the process and input output data of an electronic watermarking program.

FIG. 5 is a diagram showing a hardware configuration example.

FIG. 6 shows an example of audio judgment criteria and setting values for cases targeted for processing.

FIGS. 7A and 7B are diagrams showing another hardware configuration example.

### DETAILED DESCRIPTION OF THE EMBODIMENTS

Hereinafter, the embodiments of the present invention will be explained in detail based on the drawings. Further, in the drawings for explaining the embodiments, like reference numerals are as a rule attached to like parts, and repeated explanation of these will be omitted.

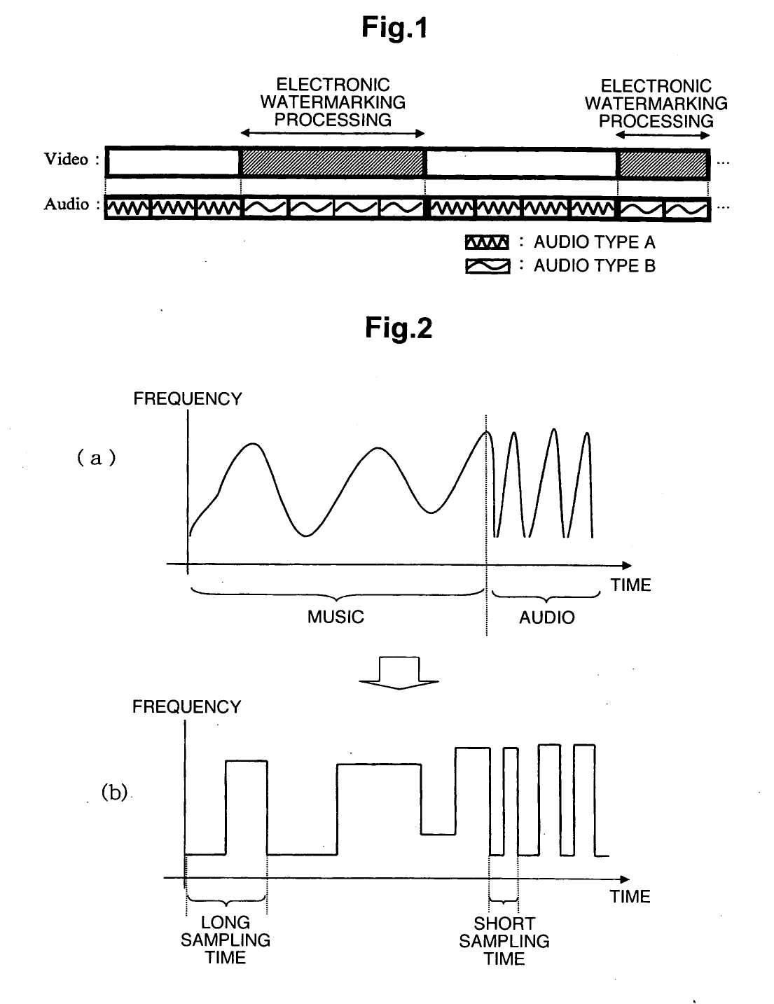

FIG. 1 is an explanatory diagram showing an example of a basic outline of the process occurring in an electronic watermarking program, method, and apparatus.

In the case of embedding electronic watermark information in video data in digital video content composed by including video data (video stream) and audio data (audio stream), the electronic watermarking program of the present embodiment discriminates audio classes for audio data, and lets a computer execute limitatively the embedding of watermark information by targeting the video data partial domains corresponding to the audio data partial domains judged to be music.

In most cases, digital video content has a video data portion comprising images and an audio data portion comprising audio combined into a set. Specifically, digital video content is data with a format for which, by a reproduction means, video data and audio data function as content by being reproduced in a temporally synchronized manner. Also, the audio data part corresponding to the video data part claiming the copyright within the digital video content can, in terms of audio classes, in most cases be classified into either music or voice. E.g., this is the case where background music (BGM) is played in a certain video scene, the speech of a voice is heard, or the like.

In this way, in case several audio classes (music and voice) are included in the audio data constituting digital video content, there is performed a discrimination of the audio class for the audio data, and, depending on the audio data partial domain, the data is classified into music, voice, or the like. Based on this discrimination, the video domains targeted for electronic watermarking processing are limited to scenes (video data partial domains) for which music is reproduced synchronously. Next, based on this limitation, the electronic watermarking process is carried out for the copyright protection, etc., of the video data partial domain targeted for electronic watermarking processing.

An audio data partial domain is audio data within a certain reproduction time period of the whole of the audio data. A video data partial domain is video data (an ensemble of frames) within a certain reproduction time period of the whole of the video data.

As a process to discriminate audio classes occurring in audio data, there is e.g. performed a classification into two classes, Music/Other Audio, for the audio data partial domains. Alternatively, a process mode may be chosen wherein a classification into multiple classes, Music/Voice/Other Audio, is performed.

In each embodiment of the present invention, in the case of embedding electronic watermark information for, copyright protection etc. with respect to video data constituting the video images in the digital video content, a discrimination of the audio classes is performed relative to the audio data (“Audio” in FIG. 1) corresponding to, i.e. being reproduced synchronously with, the video data (“Video” in FIG. 1).

For the discrimination relative to the audio classes, the characteristics of the waveform of the audio stream in the digital video content are examined, i.e. during the audio data reproduction. In particular, attention is paid to whether, in the audio stream part, sound is heard continuously or whether it is heard intermittently. In other words, attention is paid to the size of the variations in the frequency of the analog sound waveform during sampling, and to the size of the sampling width occurring during sampling.

By this discrimination, the audio data are divided by audio class into audio data partial domains. E.g., in the case of FIG. 1, the audio data is classified into two classes, audio data A and audio data B. This discrimination is performed on the basis of the differences in sampling characteristics in the audio stream. Based on the discrimination of audio classes in the audio data, the domains targeted for electronic watermarking processing with respect to the whole of the video data domains are limited to partial domains reproduced synchronously with a specific audio type. E.g., in the case of FIG. 1, the domains targeted for electronic watermarking processing are limited to audio type B. And then, based on this limitation, the electronic watermarking process for protecting its copyright is carried out with respect to the video data partial domain targeted for electronic watermarking processing. As a result of this, the computing volume required for electronic watermarking processing is reduced.

FIG. 2, (a) (b) are diagrams showing the characteristics of sampling (A/D conversion) with respect to analog sound. (a) shows an example of the waveform of analog sound, and (b) shows its sampled digital waveform. As shown in these figures, in case analog sound is digitized, the process is generally performed by taking a longer sampling width (sampling time) for domains, like music, characterized by sound being heard comparatively continuously and by few frequency variations, and by taking a shorter sampling width (sampling time) for domains, like voice, characterized by sound being heard comparatively intermittently and by numerous frequency variations. In the audio data, the portions of digital waveforms after sampling corresponding to portions where the frequency variations in the analog waveform before sampling are few have a comparatively long sampling width (sampling time).

Taking into account general sampling characteristics, e.g. by examining the size of the sampling width in the audio data, it is judged that the audio data partial domain is music. In addition, regarding audio data partial domains where there is e.g. a high ratio of long sampling widths, these are judged to be music. Next, regarding video data partial domains corresponding to these audio data partial domains, they are targeted for electronic watermarking processing, and the electronic watermarking process is carried out, with a limitation to these.

Also, the discrimination of audio classes in the audio data partial domains is performed by examining the size of the sampling width during sampling in the audio data partial domains, in particular the appearance ratio and the number of appearances of long windows and short windows. Then, the appearance ratio and the like are compared to prescribed threshold values, and the domains are divided into music and voice based on whether the values are above or below the threshold.

Moreover, the information concerning the size etc. of the sampling width may be obtained by referring to the sampling width information etc. included in the format of the header information etc. in the digital video content, or by separately performing the process of computing the size etc. of the sampling width with respect to the audio data.

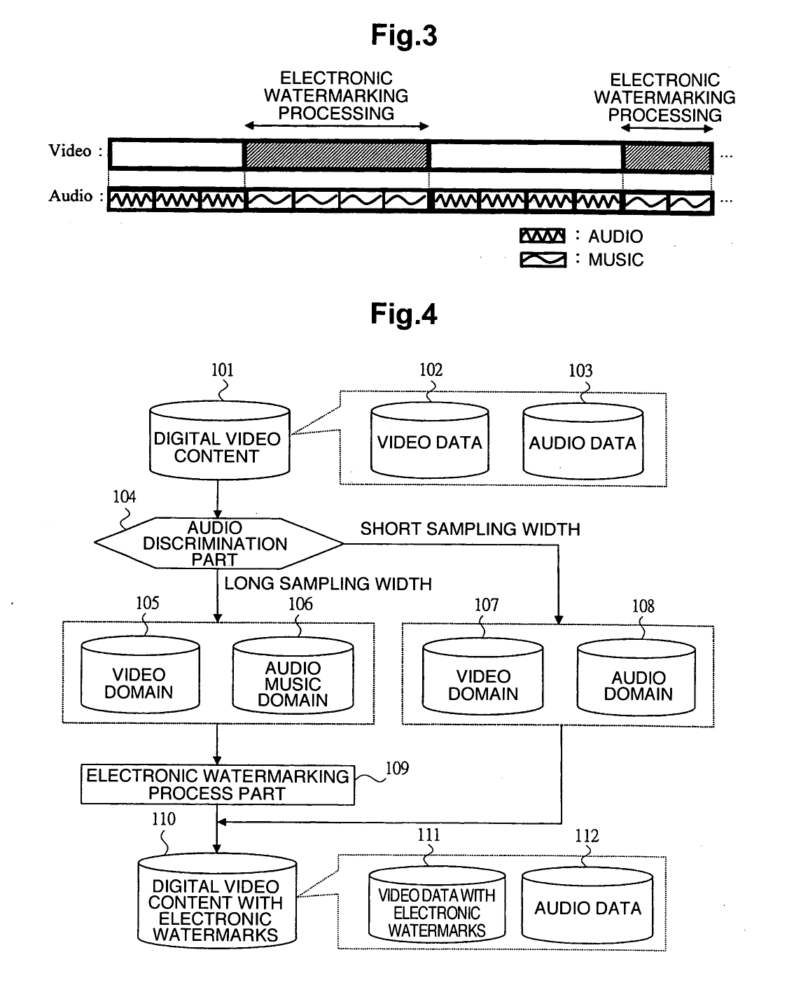

FIG. 3 is an example showing the outline of the process of the electronic watermarking program. In addition, FIG. 4 is a block diagram showing the process and the input output data of the electronic watermarking program in the present embodiment.

In the present embodiment, an audio class discrimination is performed relative to the audio data of the data constituting the digital video content and, depending on the audio data partial domain, is classified into two types, music and voice. Based on this discrimination, the video data domains targeted for the electronic watermarking process are limited to those video data partial domains for which music is synchronously reproduced. Then, based on this limitation, the electronic watermarking process for copyright protection etc. is carried out with respect to the video data partial domains targeted for electronic watermarking processing. The slanting-line domains in the drawing are domains where electronic watermark data are embedded in the video data. By these electronic watermark data, the corresponding video portions are protected.

In FIG. 4, digital video content 101 targeted for processing by the electronic watermarking program of the embodiment is composed by including digitized video data 102 and likewise digitized audio content 103. As a format intended for digital video content 101, there is e.g. MPEG-2. In the case of MPEG-2, video data and audio data are not only digitized, but an encoding process also for both data is performed. Digital video content 101 is, e.g. in the case of MPEG-2, decoded by the reproduction means, and video data 102 and audio data 103 function as content by being reproduced synchronously in terms of time. The electronic watermarking program of the present embodiment is, making a rough classification, composed of an audio discrimination part 104 and an electronic watermarking process part 109.

Audio discrimination part 104 is a processing part performing an audio class discrimination process for handling music and voice separately in the audio data 103 portions of digital video content 101. Audio discrimination part 104 inputs digital video content 101 and discriminates audio classes, by a method to be subsequently described, relative to audio data 103 included therein, classifying them into portions judged to be music and portions judged to be voice. Moreover, a classification into silent or like Other portions may be performed. In particular, in the embodiment of FIG. 3, a judgment is passed for audio data 103 on whether there is a music portion or not, and the audio data partial domains judged to be music are targeted for the electronic watermarking process in electronic watermarking process part 109. Audio discrimination part 104, by this discrimination process, divides audio data 103 into an audio music domain 106, judged to be music, and audio voice domain 108, judged to be voice. Moreover, video data 102 are divided into partial domains corresponding to each domain 106, 108. A video domain 105 is the video data partial domain reproduced synchronously with audio music domain 106. Also, a video domain 107 is the video data partial domain reproduced synchronously with audio voice domain 106.

Electronic watermarking part 109 is a processing part performing the process of embedding electronic watermark information in video data 102. Electronic watermarking part 109, after processing in audio discrimination part 104, targets video domain 105 for electronic watermarking processing, and carries out the process of embedding electronic watermark data in it. The video data partial domain with electronic watermarks included, output after processing in electronic watermarking part 109, is joined to video domain 107, which is not targeted for electronic watermarking processing.

Digital video content 110 produced in this way, with electronic watermarks included, is composed by including video data 111 with electronic watermarks included, and audio data 112. Video data 111, with electronic watermarks included, are data in which electronic watermarks are embedded in video domain 105, selected from among video data 102, by the electronic watermarking processing in electronic watermarking part 109.

Next, an explanation will be given of the process operation of audio discrimination part 104. In audio discrimination part 104, the sampling width for each portion of audio data 103 of input digital video content 101 is checked and, based on the size of the sampling widths, the portions are designated as audio data partial domains corresponding to music. E.g., in the partial domains of audio data 103, in case there is a high ratio of portions with long sampling widths, or in case the portions with long sampling widths continue without interruption, those partial domains are judged to correspond to music. These become audio music domains 106. And then, audio discrimination part 104 judges that electronic watermarking processing is necessary with respect to the video data partial domains which are synchronously reproduced with these audio music domains 106. These become video domains 105. From among the whole of video data 102, video domains 105 are set to be targeted for electronic watermarking processing. The video domains 105, set to be targeted for electronic watermarking processing, are input to electronic watermarking process part 109 and are subjected to the electronic watermarking process. Also, in the partial domains of audio data 103, in case the ratio of portions with short sampling widths is high, or in case the portions with short sampling widths continue, those partial domains are judged to correspond to voice. These become audio voice domains 108.

In audio discrimination part 104, video data partial domains other than the video domains 105 judged to be targeted for electronic watermarking processing, here i.e. the video domains 107 corresponding to audio voice domains 108, are not targeted for electronic watermarking processing and are output without modification.

The discrimination between music and voice types in audio discrimination part 104 is performed by drawing mainly on digital video content 101 metadata and header information etc. included in audio data 103. In most cases, at the time of generating digital content 101, various pieces of information concerning those data are generated as metadata or header information and are utilized, because they are described in the interior of digital video content 101 or in a related exterior. In the present embodiment, the attribute information including sampling width information in audio streams is appended to audio data 103. Audio discrimination part 104 makes reference, at the time of the discrimination process, to this sampling width information to check the size of the sampling widths of the audio partial domains and, based on this check, designates whether to include music portions or not, or their locations.

Alternatively, audio discrimination part 104, may, concerning the information on these sampling widths etc., acquire it by carrying out separate analytical processing of audio data 103. Also, apart from sampling width information, information making it possible to compute information on the size of the sampling widths may be utilized. Alternatively, in case there is in advance included identity information (a flag) giving information on whether the audio class is Music or Voice, for each partial domain in audio data 103, this [information] may be utilized to perform a classification into Music, Voice, or the like.

An example of processing in audio discrimination part 104 is shown. This process is performed while audio data 103 inside digital video content 101 are suitably read into a memory for discrimination processing. E.g., for the audio data partial domain of a prescribed time period from among the data read in, the number of appearances of long and short sampling widths is calculated, and in case the ratio accounted for by the time for which the sampling width is judged to be long is higher than the ratio accounted for by the time for which the sampling width is judged to be short, the partial domain is judged to be music. As the audio data partitioning method for judgment, time domains are e.g. divided so as to correspond to frames (individual screens constituting the video) constituting video data 102. And then, an audio class discrimination process is performed by examining the size of the sampling widths for each of the classified audio data partial domains.

Alternatively, in case a threshold value is provided for judging that it is at least a long sampling width, the cumulative value of the sampling widths for which the threshold value is exceeded is greater than or equal to one half or the like, and the appearance ratio is greater than or equal to a perscribed value, this audio data partial domain is judged to correspond to music, since the ratio for which sampling widths are taken to be long in this partial domain is high. As for the case of judging voice portions, for a partial domain for which on the contrary the appearance ratio of short windows is high, it is judged to be voice.

For the purpose of checking the sampling widths, audio discrimination part 104 utilizes information on long windows and short windows during analog sound sampling, included in audio data 103. A window expresses the sampling width used in unit sampling with respect to the original analog sound waveforms constituting audio data 103. During analog sound sampling, there exists a method of performing sampling using, in response to the frequency characteristics of the analog sound being the input, two classes of sampling widths, short windows and long windows. In the case of the present embodiment, audio data 103 are taken to be data sampled with this method. In audio data 103, this window information is appended for the purpose of the audio stream reproduction.

An explanation will be given of an audio discrimination process example based on long windows and short windows. Briefly, a method for digitizing of analog data is explained. Conversion from analog data to digital data is carried out for data with a certain interval (e.g. 1024 samples or 2048 samples). At this time, in case the analytical data length (window length) does not coincide with an integer multiple of the period of the analog data, a distorted waveform ends up being processed, so the error between the actual waveform in the analog data and the waveform in the digital data increases. Accordingly, in case the period of the change in the analog data is short, the analytical data length is shortened to reduce the error. The analytical data length in the case of a long period for the change in the analog data is called a long window, and the analytical data length in the case of a short period for the change in the analog data is called a short window. In the case of the digitization of music, because sound is heard continuously in music, greater-than-expected frequency changes are few. As a result, waveforms close to actual waveforms are obtained even for long windows, so the appearance rate of short windows is low. In the case of the digitization of voice, voice includes bursty sounds etc. and is not continuous due to breaks, so short windows appear frequently. Moreover, silent spots can also be observed.

Therefore, audio discrimination part 104 calculates the ratio and number of appearances of the respective windows in the audio data partial domains. E.g., in case the number of appearances of long windows in a certain audio data partial domain is greater than or equal to a prescribed value, since the ratio of portions with long sampling widths is high, the frequency variations in the analog waveform corresponding to this are judged to be few, so this domain is judged to correspond to music. This audio data partial domain is judged to correspond to music.

Moreover, as another discrimination criterion, the number of continuous appearances and the continuous times of long and short sampling widths may be calculated. Alternatively, the average sampling width may be calculated. And then, the calculated value is compared against a prescribed threshold value, and there is performed a classification into Music/Voice based on which is higher or which is lower. As yet another discrimination criterion, it may be examined to which extent the long windows or the short windows in the audio data appear continuously. For partial domains wherein appearances of long windows in the audio data continue without interruption at or above a prescribed level, i.e. partial domains where spots with long sampling widths continue, they are judged to correspond to music. In the contrary case, they are judged to be voice.

In the electronic watermarking program of the present embodiment, there is acquired, from a played audio stream corresponding to a video scene, a window shape of arbitrary range, i.e. information on long windows and short windows, and in case the frequency of appearance of short windows in the acquired window shape is less than a prescribed threshold value, it is judged that that partial domain is a music scene, i.e. a scene in which music can be heard. Also, apart from that, in case the frequency of appearance of short windows is greater than or equal to the threshold value, that partial domain is judged to be a voice scene (conversation scene). An analytical method using long window and short window information can e.g. be utilized in the “MPEG-2 AAC”, “MP3”, and “Dolby™ AC3™” formats, or the like.

Further, in FIG. 4, the configuration was one wherein the digital audio data was discriminated as being either Music or Voice, but a classification adding Other portions for silences etc. may be performed. In addition, in case there are portions in audio data 103 which are difficult to discriminate into audio as audio classes, one may, without performing a division into audio for the audio data partial domains, set the video data partial domains reproduced synchronously with these domains as targeted for electronic watermarking processing and embed electronic watermarks in them.

As yet another process, the audio discrimination may be performed by combining it with a discrimination of colors or movements, etc., in the partial domains of video data 102. E.g., in a video data partial domain, it is examined whether human skin colors are frequently included as colors. In case skin colors are frequently included, it is judged that the audio data partial domain reproduced synchronously with it has a high probability of being voice.

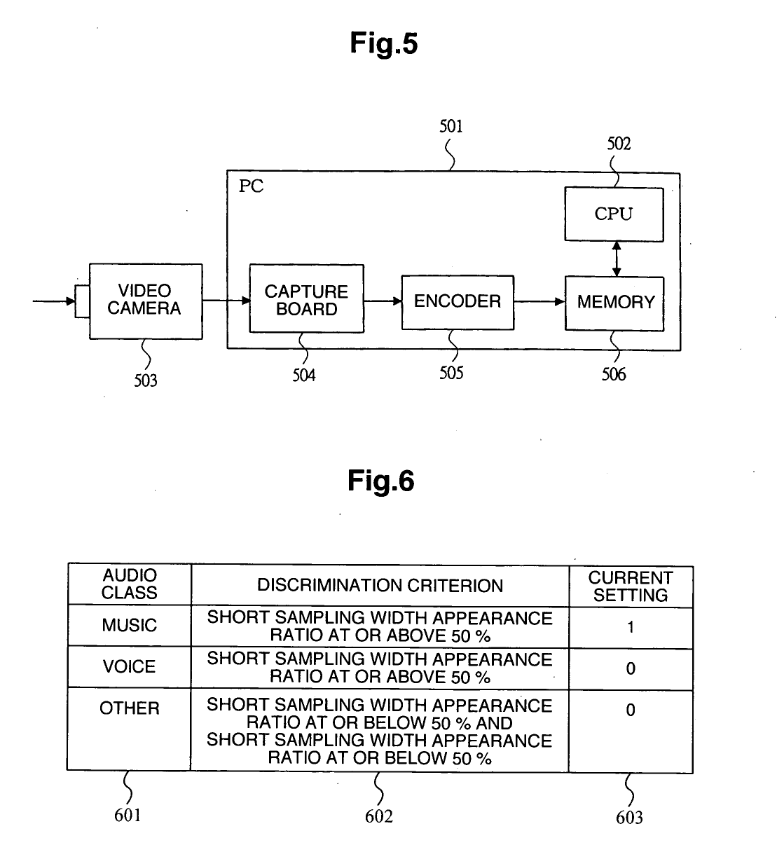

FIG. 5 shows an example of a hardware configuration serving as a platform to execute the electronic watermarking program. PC (Personal Computer) 501 is of a configuration having a CPU 502, a capture board 504, an encoder 505, and a memory 506. A video camera 503 is connected by a communication line to capture board 504 of PC 501. PC 501 holds the present electronic watermarking program in a main memory, which is not illustrated. It may be stored on an HDD or a flexible disk. CPU 502 implements each process by reading the present electronic watermarking program from the main memory or the like and executing it. Consequently, in the present embodiment, audio process part 104 and electronic watermarking process part 109 are implemented by CPU 502. Video camera 503 is an apparatus recording images and sound which inputs video images and sound serving as the basis for creating digital video content 101. Here, an illustration of the microphone etc to record the sound is omitted, and image and sound are shown together as one line.

The video images and sound input into video camera 503 are processed as analog signals and input to capture board 504. Capture board 504 performs digitization, i.e. sampling, of the input video image and sound analog signals, and performs the generation of video data 102 and audio data 103 serving as the constituent portions of digital video content 101. At the time of this sampling, it performs processing, with respect to analog sound waveforms, using the sampling widths of e.g. the two classes long windows and short windows, and appends the sampling width information to the data as header information. The analog sound is sampled with a sampling width suited to its frequency characteristics. Encoder 505 is a device for carrying out the encoding (compression) process etc. required in the MPEG format etc. for video data 102 and audio data 103. This may be configured in an integrated manner inside capture board 504. Video data 102 and audio data 103, generated through capture board 504 and encoder 505, are stored in memory 506. Based on these data, digital video content 101 is generated.

The audio discrimination process and the electronic watermarking process based on the present electronic watermarking program are carried out by CPU 502 with respect to video data 102 and audio data 103 in memory 506. As a result, digital video content 110 with electronic watermarks included is generated.

Further, in the present embodiment, there is adopted a processing mode in which the audio discrimination process and the electronic watermarking process are executed with respect to the (audio and video) data of digital video content 101, once [the data] have been completed. Without limitation to this, a processing mode may be adopted wherein the process is executed with respect to the digital video content 101 data before their completion. Also, in case the generated digital video content 101 data are located externally, it is acceptable to read these into memory 506 of PC 501, execute the present electronic watermarking program with respect to these by CPU 502, and generate digital video content 110 with electronic watermarks included.

As for the system on the electronic watermark information detection side, it is possible to follow the prior art. Also, in case it is desired to perform copyright protection etc. of an audio portion in addition to that for the video portion, an electronic watermarking process may also be carried out with respect to audio data 103 using a prescribed electronic watermarking technology.

In the present embodiment, the embedding of electronic watermark information concerning the audio data 103 portion of digital video content 101 is a separate process, and with the process in the present embodiment, a configuration is adopted wherein audio discrimination part 104 does not carry out an electronic watermarking process with respect to audio data 103 judged to be voice, or judged not to be music. However, for the purpose of protecting portrait rights etc., it is also possible, on the contrary, to adopt a configuration wherein an electronic watermarking process is performed for the voice portion.

In that case, e.g. within the process of FIG. 4, an audio class discrimination is performed for the audio data constituting the digital video content, and, depending on the audio data partial domain, it is classified into two classes of types, Music and Voice. The discrimination is e.g. carried out by discriminating the voice part for the audio data partial domain by examining the size of the sampling widths in the audio data. E.g., for audio data partial domains for which the ratio of sampling widths becoming short is high, they are judged to be voice. Then, for video data partial domains corresponding to these audio data partial domains, they are taken to be targeted for electronic watermarking, and an electronic watermarking process is carried out, with a limitation to these.

More specifically, audio process part 104 utilizes long window and short window information for the purpose of examining sampling widths. In the audio data partial domains, it calculates the ratio or the number of appearances of the respective windows, compares them against threshold values, and performs a classification into audio based on which is higher or which is lower. There is acquired, from an audio stream corresponding to a video scene, a window shape of arbitrary range, i.e. information on long windows and short windows, and in case the frequency of appearance of short windows in the acquired window shape is greater than or equal to a prescribed threshold value, that partial domain is judged to be a voice scene (conversation scene).

Based on this discrimination, in case audio discrimination part 104 has e.g. judged that the sampling width is short, contrary to the case in FIG. 4, the video domain and the audio music domain are sent to electronic watermarking process part 109, and electronic watermarking processing is performed. In case the sampling width is judged to be short, no electronic watermarking process is performed.

Alternatively, there may be adopted a configuration which performs the electronic watermarking process. and which can set the audio classes. E.g., a configuration is adopted which can modify the setting values shown in FIG. 6 by means of an input apparatus, not illustrated in FIG. 5. FIG. 6 is a diagram showing an example of setting values 603 in the case where, with respect to each audio class 601, discriminating criterion examples 602 and the decision whether to perform electronic watermarking or not are set with flags. As for these settings, a configuration wherein they are made each time the program is launched may be adopted, or a configuration wherein it is possible to arbitrarily modify the settings while the process is in progress may be adopted.

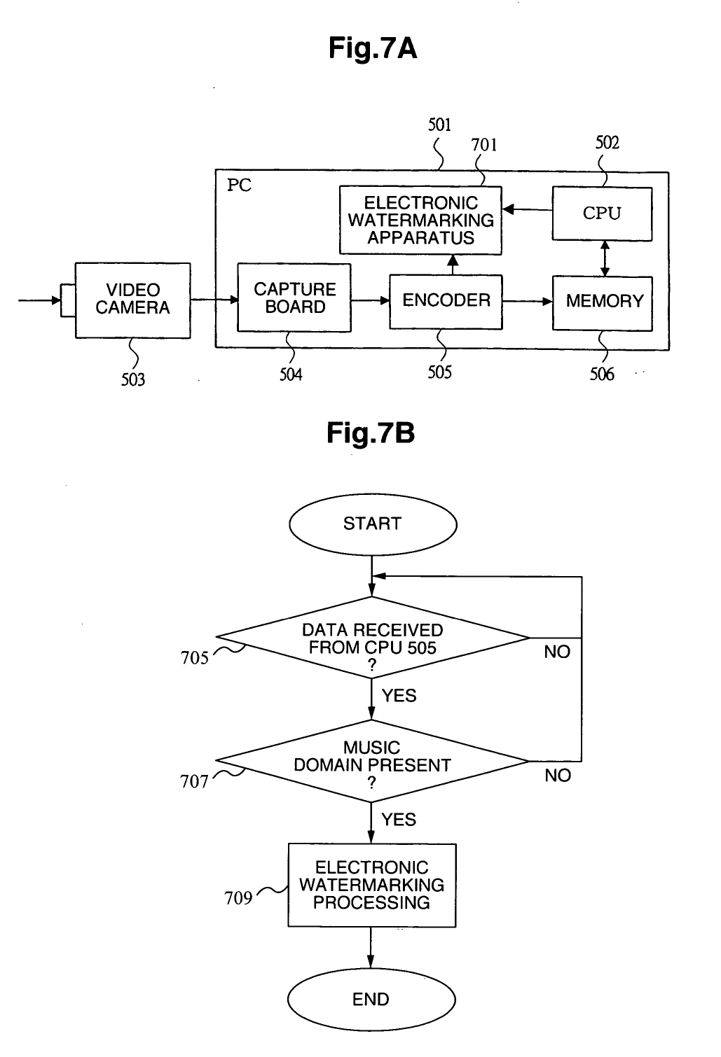

In addition, in the example of FIG. 5, a configuration was chosen wherein the CPU implements audio process part 104 and electronic watermarking process part 109, but a configuration wherein electronic watermarking process part 109 uses a separately configured electronic watermarking apparatus may also be chosen. The hardware configuration for that case is shown in FIG. 7A. In the case of FIG. 7A, data are forwarded from encoder 505 to audio process part 104 and electronic watermarking apparatus 701. The explanation is given assuming that the electronic watermarking process is performed with respect to music. In case there are audio data partial domains judged to be music, audio process part 104 (CPU 502) designates those domains and outputs the information designating those domains, e.g. frame numbers, to electronic watermarking apparatus 701.

In electronic watermarking apparatus 701, it is checked, as shown in FIG. 7B, whether there is any instruction from CPU 502 (Step 705). In case some signal has been input from CPU 502, it is checked (Step 707) whether it is a designation with respect to an audio data partial domain, i.e. whether it is music data location information. In case there is none, the apparatus is on standby until it receives an instruction from the CPU. In case the instruction was music data location information, it carries out the electronic watermarking process (Step 709) with respect to the video data corresponding to the designated audio data partial domain. In case the instruction was not music data location information, the apparatus is on standby until it receives an instruction from the CPU.

By choosing a configuration like this, it becomes possible to strive for an attainment of even higher speeds since one can utilize high-speed hardware for electronic watermarking processing.

Above, an invention made by the present inventor[s] has been specifically explained on the basis of embodiments, but the present invention is not limited to the aforementioned embodiments, and it goes without saying that it is possible to effect various modifications to it without departing from its substance.

As mentioned above, by limiting the video data domains targeted for electronic watermarking processing to those portions which are reproduced synchronously with music, it is possible to shorten the overall processing time necessary for electronic watermarking processing of the video data 102 portion of digital video content 101. It is possible to implement an increase in the efficiency of an electronic watermarking processing system, composed by including an electronic watermarking program, or a digital content generation system and method performing an electronic watermarking process. In addition, it becomes possible to shorten the processing time, even in the case of platforms for which a reinforcement of the hardware resources can not be expected.

1. An electronic watermarking method for digital content having digital video data and digital audio data including a plurality of audio classes, comprising the steps of:
storing in memory the digital video data, and the digital audio data temporally related to the digital video data;
discriminating by a processor whether the digital audio data includes or not digital audio data portions of a class targeted for electronic watermarking processing; and
embedding, by a processor, electronic watermarks in digital video data portions temporally related to the digital audio data portions of a class targeted for electronic watermarking processing, in case the digital audio data include the digital audio data portions of a class targeted for electronic watermarking processing.

2. The electronic watermarking method according to claim 1, wherein the processor, in the discriminating step, partitions the digital audio data into prescribed ranges, and discriminates whether the digital audio data portions of a class targeted for electronic watermarking processing are included or not, based on the appearance ratio of long windows during sampling within the prescribed ranges.

3. The electronic watermarking method according to claim 2, wherein the processor, in the discriminating step, judges, in case the appearance ratio of the long windows during the sampling of each of the ranges exceeds a prescribed value, digital audio data of the range to be the digital audio data portions of a class targeted for electronic watermarking processing.

4. The electronic watermarking method according to claim 1, wherein the processor, in the discriminating step, judges to be the digital audio data portions of a class targeted for electronic watermarking processing, in case the digital audio data is music.

5. The electronic watermarking method according to claim 1, further comprising:
the step wherein the digital video data and the digital audio data are A/D converted from the analog video data and the digital audio data.

6. The electronic watermarking method according to claim 1, further comprising:
the step of setting a class targeted for electronic watermarking processing.

7. An electronic watermarking method embedding electronic watermarks in digital video content including video data, and audio data reproduced synchronously with the video data, comprising the steps of:
discriminating an audio class per portion of the audio data; and
embedding electronic watermarks in the video data portions synchronized with the audio data, in case the audio class of the audio data coincides with the audio class targeted for electronic watermarking processing.

8. The electronic watermarking method according to claim 7, wherein the audio class targeted for electronic watermarking processing is music.

9. The electronic watermarking method according to claim 7, wherein the audio class discrimination is based on information on the appearance ratio of long windows and short windows during sampling in a portion of the audio data.

10. A storage medium storing an electronic watermarking program applicable to digital content having digital video data and digital audio data including a plurality of audio classes, the processor making a processor performs the steps of:
storing in memory the digital video data, and digital audio data temporally related to the digital video data;
discriminating whether the digital audio data includes or not digital audio data portions of a class targeted for electronic watermarking processing; and
embedding electronic watermarks in digital video data portions temporally related to digital audio data portions of a class targeted for electronic watermarking processing, in case the digital audio data include digital audio data portions of a class targeted for electronic watermarking processing.

11. The electronic watermarking method according to claim 10, wherein, in the discriminating step, the digital audio data is partitioned into prescribed ranges, and it is discriminated whether the digital audio data portions of a class targeted for electronic watermarking processing are included or not, based on the appearance ratio of long windows during sampling within the prescribed ranges.

12. An electronic watermarking method according to claim 10, wherein, in the discriminating step, in case the appearance ratio of the long windows during the sampling of each of the ranges exceeds a prescribed value, the digital audio data of the ranges are judged to be the digital audio data portions of a class targeted for electronic watermarking processing.

13. The electronic watermarking method according to claim 10, wherein, in the discriminating step, the processor judges to be the digital audio data portions of a class targeted for electronic watermarking processing, in case the digital audio data are music.

14. The electronic watermarking method according to claim 10, further comprising the step of A/D converting from analog video data and digital audio data to the digital video data and the digital audio data.
